(19) United States
(12) Patent Application Publication
(10) Pub. No.: US 2011/0055854 A1
(43) Pub. Date: Mar. 3, 2011

(54) IMAGE FORMING APPARATUS AND METHOD

(75) Inventors: Takanao Kawai, Osaka (JP); Takashi Araki, Osaka (JP); Sun Changsong, Osaka (JP); Yosuke Oka, Osaka (JP)

(73) Assignee: KYOCERA MITA CORPORATION, Osaka (JP)

(21) Appl. No.: 12/852,085

(22) Filed: Aug. 6, 2010

(30) Foreign Application Priority Data
Aug. 25, 2009 (JP) 2009-194812

(51) Int. Cl. G06F 9/44

(52) U.S. Cl. 719/327

(57) ABSTRACT

An image forming apparatus includes: a peripheral device interface, an interface driver configured to control the peripheral device interface, a platform configured to provide a runtime environment for a program written in a predetermined language on an operating system, and a device driver configured to operate on the platform and to cause the interface driver to control a peripheral device while performing communications with the peripheral device through the peripheral device interface.

### INCORPORATION BY REFERENCE

This application is based upon and claims the benefit of priority from corresponding Japanese Patent Application No. 2009-194812, filed in the Japan Patent Office on Aug. 25, 2009, the entire contents of which is incorporated herein by reference.

### BACKGROUND

1. Field of the Invention

The present invention relates to an image forming apparatus and a method.

2. Description of the Related Art

On a personal computer (PC), a device driver is stored on or added to a mass storage hard disk drive (HDD). Further, an operating system (OS) such as Windows (registered trademark) on the PC has a function of loading the device driver stored on the HDD. However, the HDD provided to an image forming apparatus has a small capacity. Furthermore, since the OS on the image forming apparatus is not designed with the intent of being connected to a new peripheral device, most image forming apparatuses have no function of loading the device driver stored on the HDD.

When the image forming apparatus such as a printer, a scanner, a copier, a facsimile apparatus, or a multifunction peripheral (MFP) is connected to a peripheral device such as an

IC card reader, the device driver for the peripheral device must be installed onto the image forming apparatus. Such a device driver for the peripheral device is generally stored as firmware in a nonvolatile memory within the image forming apparatus for the above-described reason.

However, when the device driver for the peripheral device connected directly to the image forming apparatus is stored as firmware in the nonvolatile memory within the image forming apparatus, the firmware in the nonvolatile memory needs to be rewritten in order to control a new peripheral device connected to the image forming apparatus. Therefore, a process for installing the device driver is complicated due to the firmware update, and if the firmware update fails, the image forming apparatus becomes inoperable.

### SUMMARY

The present disclosure relates to an image forming apparatus and a method that may easily add or delete a device driver for a new peripheral device connected to an image forming apparatus .

According to one aspect of the present disclosure, there is provided an image forming apparatus that comprises a peripheral device interface, an interface driver, a platform, and a device driver. The peripheral device interface is configured to connect a peripheral device to the image forming apparatus; and the interface driver is configured to control the peripheral device interface. The platform is configured to provide a runtime environment for a program written in a predetermined language on an operating system of the image forming apparatus. The device driver is configured to operate on the platform and cause the interface driver to control the peripheral device while performing communications with the peripheral device through the peripheral device interface.

According to another aspect of the present disclosure, there is provided an image forming method that comprises: connecting, via a peripheral device interface, a peripheral device to an image forming apparatus; controlling, via an interface driver, the peripheral device interface; providing, via a platform, a runtime environment for a program written in a predetermined language on an operating system; and causing, via a device driver configured to operate on the platform, the interface driver to control the peripheral device while performing communications with the peripheral device through the peripheral device interface.

Additional features and advantages are described herein, and will be apparent from the following Detailed Description and the figures.

### BRIEF DESCRIPTION OF THE DRAWINGS

In the accompanying drawings:

FIG. 1 is a block diagram illustrating a configuration of an image forming apparatus according to an embodiment of the present disclosure; and

FIG. 2 is a flowchart illustrating an operation of the image forming apparatus when an IC card reader peripheral device is newly connected to the image forming apparatus.

### DETAILED DESCRIPTION

Hereinafter, description is made of an embodiment of the present disclosure with reference to the accompanying drawings.

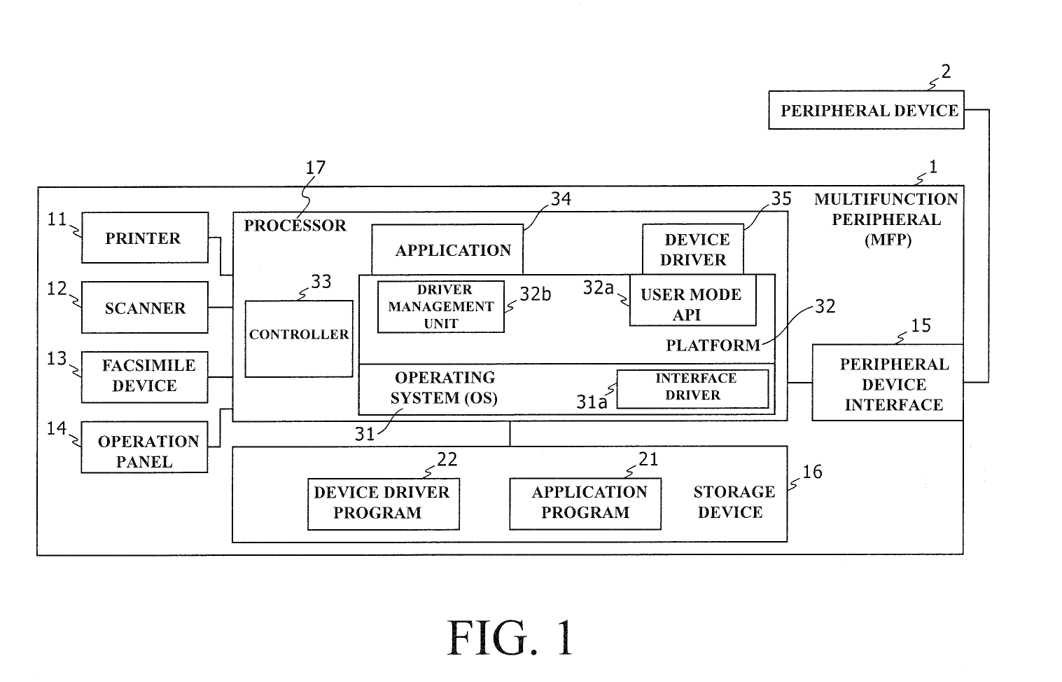

In FIG. 1, a multifunction peripheral (MFP) 1 is an example of an image forming apparatus, and includes a printer 11, a scanner 12, a facsimile device 13, an operation panel 14, a peripheral device interface 15, a storage device 16, and a processor 17.

The printer 11 prints a document image based on print data. The scanner 12 optically reads a document image from a document and generates image data based on the document image. The facsimile device 13 generates a facsimile signal from document data and transmits the facsimile signal, and also receives a facsimile signal and converts the facsimile signal into document data.

The operation panel 14 includes a display device that displays thereon various kinds of information to the user and an input device that detects a user operation. Examples of the display device include a liquid crystal display (LCD). Examples of the input device include a key switch and a touch panel.

The peripheral device interface 15 causes the MFP 1 to be connected to a peripheral device 2 in wireless and/or wired manner. In this embodiment, the peripheral device interface 15 is a host interface of a universal serial bus (USB®).

The storage device 16 stores various programs and various kinds of data. The storage device 16 includes nonvolatile storage medium such as a hard disk drive or a nonvolatile memory.

Pre-stored in the storage device 16 are programs necessary for the operation of the MFP 1 (programs for realizing an operating system 31, a platform 32, and a controller 33 described later) and data. Further stored in the storage device 16 are an application program 21 and a device driver program 22.

The processor 17 is a computer including a central processing unit (CPU), a read only memory (ROM), and a random access memory (RAM). The processor 17 loads programs from the ROM, the storage device 16, or the like into RAM and causes the CPU to execute the programs to thereby realize various processing units.

After the start of the MFP 1, the various programs stored in the storage device 16 are executed by the processor 17. The processor 17 realizes the processing units such as the operating system 31, the platform 32, the controller 33, an application 34, and a device driver 35.

The operating system 31 includes an interface driver 31a that controls the peripheral device interface 15.

The platform 32 provides a runtime environment under which a program written in a predetermined language may be executed. The platform 32 may include an open services gateway initiative (OSGi) framework and a JAVA virtual machine executing a JAVA application in JAVA bytecode.

The platform 32 includes a user mode application program interface (API) 32a that causes the device driver 35 to control the interface driver 31a while operating in a user mode, and a driver management unit 32b that performs management (such as addition and deletion) of the device driver 35.

The controller 33 controls the printer 11, the scanner 12, the facsimile device 13, and the operation panel 14 and performs data input/output with respect thereto. A controller API is implemented for controlling of the controller 33. The controller API causes the controller 33 to perform an instruction from the application operating on the platform 32 performing the functions of the printer 11, the scanner 12, the facsimile device 13, and the operation panel 14 and to perform the data input/output with respect thereto.

The application 34 is realized by the application program 21 executed on the platform 32. The application 34 controls the controller API to cause the controller 33 to perform an operation specified by a function performance request. Accordingly, the controller 33 controls the printer 11, the scanner 12, the facsimile device 13, and the operation panel 14 to perform the operation specified by the function performance request. Further, in a case of controlling the peripheral device 2, the application 34 causes the device driver 35 to control the peripheral device 2. In this embodiment, the application 34 maybe installed as a bundle in the OSGi framework. In other words, the application program 21 maybe installed as a Java archive (JAR) file.

The device driver 35 operates on the platform 32, and causes the interface driver 31a to control the peripheral device 2 while performing communications with the peripheral device 2 through the peripheral device interface 15. The device driver 35 may be a JAVA application that is a bundle in the OSGi framework. In other words, the device driver program 22 maybe installed as a JAR file. Within the OSGi framework, the device driver 35 can be added dynamically, and cooperates with the application 34 that operates also as another bundle on the platform 32.

Next, description is made of the operation of the above-described apparatus.

After the MFP 1 is powered on, the processor 17 loads a program (not illustrated) from the storage device 16 and executes the program. The operating system 31 and the platform 32 are thus realized. Further, the processor 17 loads and executes the application program 21. The application 34 operates on the platform 32.

It should be noted that if the device driver 35 is made resident, the processor 17 loads and executes the device driver program 22 at the start of the MFP 1. On the other hand, if the device driver 35 is operated when the application 34 is called, the processor 17 loads and executes the device driver program 22 when the application 34 calls the device driver 35.

The application 34 controls the controller 33 to thereby control the printer 11, the scanner 12, the facsimile device 13, and the operation panel 14. Further, the application 34 may detect a user operation performed with respect to an input device on the operation panel 14, and cause the controller 33 to control the printer 11, the scanner 12, the facsimile device 13, and the operation panel 14 in order to execute an operation corresponding to the user operation.

Further, in a case of controlling the peripheral device 2 with the operation of the printer 11, the scanner 12, the facsimile device 13, or the operation panel 14, the application 34 calls the device driver 35 for the peripheral device 2 to control the peripheral device 2. At this time, by controlling the interface driver 31a through the user mode API 32a, the device driver 35 controls the peripheral device interface 15 to transmit a command to the peripheral device 2 and to supply the application 34 with a response thereto upon reception of the response.

For example, when the peripheral device 2 is an IC card reader and when the application 34 performs user authentication based on an IC card, the device driver 35 accesses the IC card reader to read identification information such as a user ID from the IC card presented by the user and performs a user authentication processing based on the identification information.

Accordingly, the device driver 35 for the peripheral device 2 operates on the platform 32.

Next, description is made of installation of the device driver 35.

The MFP 1 includes the peripheral device interface 15 and the interface driver 31a for the peripheral device interface 15. Therefore, the MFP 1 establishes physical connections to various peripheral devices having an interface conforming to an interface standard of the peripheral device interface 15 and performs communications according to the interface standard. However, in order to cause a peripheral device to operate properly, a host driver (for example, device driver 35) is necessary to transmit commands specified previously for the peripheral device and receive operation results.

Therefore, when a peripheral device different from the peripheral device 2 is connected to the peripheral device interface 15, a device driver for the peripheral device is installed onto the MFP 1. The device driver has the same format as the device driver 35 (that is, a bundle in the OSGi framework). When a new device driver is installed, the driver management unit 32b stores the device driver program 22 in the storage device 16 and registers the device driver on the platform 32. The device driver program 22 may be installed from a removable recording medium (such as a USB memory) by connecting the removable recording medium to the peripheral device interface 15, or may be installed from a server on a network by the communication device (not illustrated).

The MFP 1 may be shipped without the above-described device driver 35 being installed, and the above-described device driver 35 may be installed after delivery in the same method as described above by a user or by a vendor.

To uninstall the device driver 35, the driver management unit 32b deletes the registration of the device driver program 22.

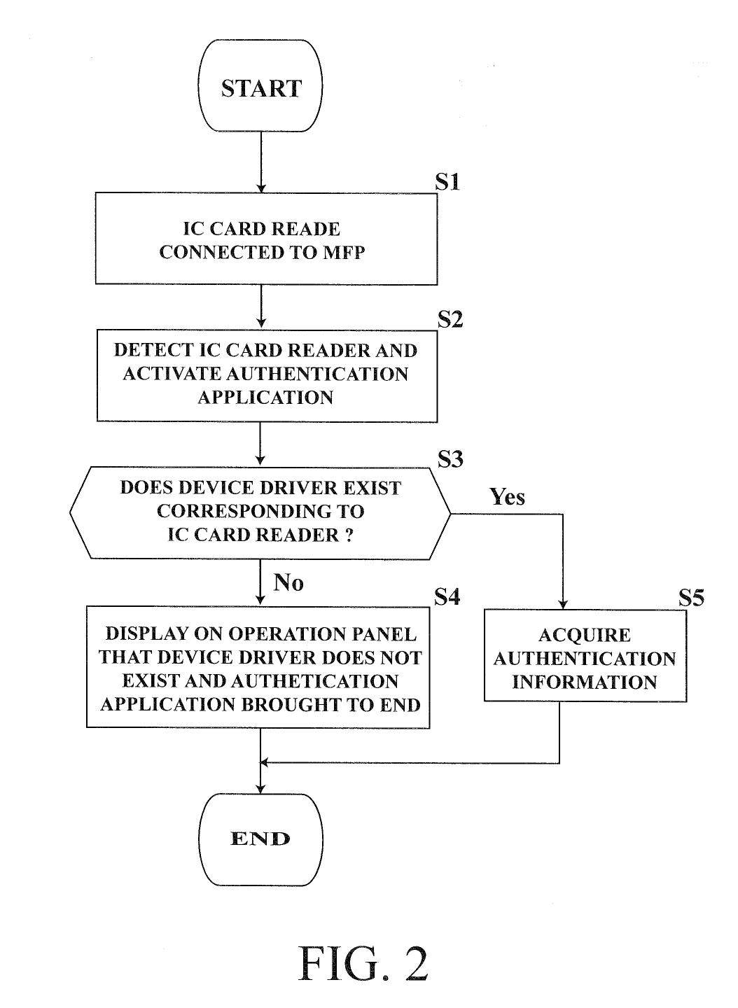

FIG. 2 is a flowchart illustrating an operation of the image forming apparatus when an IC card reader is newly connected to the image forming apparatus.

In Step S1, the IC card reader is connected to the MFP 1 through the peripheral device interface 15. Then, for example, when the MFP 1 is powered on, in Step S2, the MFP 1 controls the peripheral device interface 15 by the interface driver 31a to detect the IC card reader by communicating with the IC card reader and activate a user authentication application (as one example of the application 34).

In Step S3, the MFP 1 decides whether or not a device driver 35 corresponding to the connected IC card reader, which operates on the platform 32, already exists. If it is decided that the device driver 35 exists, authentication information (for example, an ID and a password) is acquired through the device driver 35 in Step S5. Then, the user authentication application performs authentication.

If it is decided that the device driver does not exist, for example, in Step S4, it is displayed on the operation panel of the MFP 1 that the device driver does not exist, and the user authentication application is brought to an end. Then, for example, the MFP 1 searches a server device on the network for the device driver, and if the device driver exists, installs the device driver via the network.

As described above, the MFP 1 as the image forming apparatus according to the embodiment of the present invention includes: the peripheral device interface 15; the interface driver 31a that controls the peripheral device interface 15; the platform 32 that provides a runtime environment for a program written in a predetermined language (here, in JAVA bytecode) on the operating system 31; and the device driver 35 that operates on the platform 32 and causes the interface driver 31a to control the peripheral device 2 by communicating with the peripheral device 2 through the peripheral device interface 15.

The device driver is thus operated on the platform 32, which makes it easy to add or delete the device driver for the peripheral device connected to the MFP 1.

Further, according to the above-described embodiment, the device driver that operates on the platform 32 is additionally installed corresponding to the addition of the peripheral device 2. The additionally installed device driver causes the interface driver 31a to control the added peripheral device while performing communications with the peripheral device through the peripheral device interface 15.

This makes it possible to connect a new peripheral device to the MFP 1 and to control the peripheral device at the MFP 1.

Further, according to the above-described embodiment, the platform 32 includes the user mode API 32a that causes the device driver 35 to control the interface driver 31a while operating in a user mode.

This makes it possible that the device driver 35 need not operate in a kernel mode. Accordingly, a failure rarely occurs on the apparatus due to the addition of the device driver, and it becomes easy to create and add a new device driver.

The present invention includes various other embodiments. For example, other designs can be used in which the above-described components are each performed.

For example, in the above-described embodiment, the IC card reader exemplifies the peripheral device 2, but the peripheral device 2 maybe another device for authentication such as a fingerprint scanner for authentication of fingerprints. Further, a network communication device or a communication device such as a modem may be connected as the peripheral device 2.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. An image forming apparatus, comprising:
a peripheral device interface configured to connect a peripheral device to the image forming apparatus;
an interface driver configured to control the peripheral device interface;
a platform configured to provide a runtime environment for a program written in a predetermined language on an operating system of the image forming apparatus; and
a device driver configured to operate on the platform and cause the interface driver to control the peripheral device while performing communications with the peripheral device through the peripheral device interface.

2. The image forming apparatus according to claim 1, wherein:
the device driver is installed in response to an addition of a peripheral device.

3. The image forming apparatus according to claim 1, wherein the platform comprises a user mode API configured to control the interface driver while the device driver is operating in a user mode.

4. The image forming apparatus according to claim 1, further comprising an application configured to operate on the platform and control the peripheral device through the device driver.

5. The image forming apparatus according to claim 4, further comprising a controller configured to control one or more devices selected from the group consisting of a printer, a scanner, a facsimile device, and an operation panel;
wherein the application causes the controller to control the at least one or more devices selected from the group consisting of the printer, the scanner, the facsimile device, and the operation panel.

6. The image forming apparatus according to claim 4, wherein the device driver controls the peripheral device interface by controlling the interface driver through the user mode API to transmit a command to the peripheral device and to supply the application with a response upon reception of the response.

7. The image forming apparatus according to claim 4, wherein:
the peripheral device comprises an IC card reader; and
the application comprises an authentication function involving the IC card reader.

8. The image forming apparatus according to claim 4, wherein:
the platform comprises a JAVA virtual machine and an OSGi framework; and
the application is installed as a bundle in the OSGi framework.

9. The image forming apparatus according to claim 8, wherein the device driver is installed as a bundle in the OSGi framework.

10. The image forming apparatus according to claim 9, wherein the application and the device driver communicate with each other on the platform via the OSGi framework.

11. An image forming apparatus, comprising:
a peripheral device interface configured to connect a peripheral device to the image forming apparatus;
an interface driver configured to control the peripheral device interface;
a platform configured to provide a runtime environment for a program written in a predetermined language on an operating system of the image forming apparatus;
a controller configured to control one or more devices selected from the group consisting of a printer, a scanner, a facsimile device, and an operation panel;
a device driver configured to operate on the platform and cause the interface driver to control the peripheral device while performing communications with the peripheral device through the peripheral device interface; and
an application configured to operate on the platform and control the peripheral device through the device driver and cause the controller to control one or more of the devices selected from the group consisting of the printer, the scanner, the facsimile device, and the operation panel.

12. The image forming apparatus according to claim 1, further comprising a storage device configured to store a program,
wherein the program comprises a device driver program and an application program.

13. The image forming apparatus according to claim 12, wherein the device driver program and the application program are each stored as a JAR file.

14. The image forming apparatus according to claim 12, wherein:
the platform comprises a driver management unit configured to perform management of the device driver; and
the driver management unit stores the device driver program in the storage device and registers the device driver on the platform.

15. The image forming apparatus according to claim 14, wherein the driver management unit is configured to remove the device driver by erasing the device driver program from the storage device, and causing the registration of the device driver to be deleted from the platform.

16. An image forming method, comprising:
connecting, via a peripheral device interface, a peripheral device to an image forming apparatus;
controlling, via an interface driver, the peripheral device interface;
providing, via a platform, a runtime environment for a program written in a predetermined language on an operating system of the image forming apparatus; and
causing, via a device driver operating on the platform, the interface driver to control the peripheral device while performing communications with the peripheral device through the peripheral device interface.

17. The image forming method according to claim 16, further comprising:
installing the device driver configured to operate on the platform in response to a detected addition of a peripheral device.

18. The image forming method according to claim 16, further comprising:
controlling, via an application configured to operate on the platform, the peripheral device through the device driver.

19. The image forming method according to claim 18, wherein the platform comprises a JAVA virtual machine and an OSGi framework; and
the application is installed as a bundle in the OSGi framework.

20. The image forming method according to claim 19, further comprising installing the device driver as a bundle in the OSGi framework.

21. The image forming method according to claim 20, wherein the application and the device driver communicate with each other on the platform via the OSGi framework.

22. The image forming method according to claim 16, wherein the platform comprises a user mode API configured to control the interface driver while the device driver is operating in a user mode.
